(19) United States
(12) Patent Application Publication
(10) Pub. No.: US 2023/0332908 A1
(43) Pub. Date: Oct. 19, 2023

(54) MOVEMENT PLAN PROPOSAL METHOD, MOVEMENT PLAN PROPOSAL DEVICE, AND MOVEMENT SYSTEM

(71) Applicant: TOYOTA JIDOSHA KABUSHIKI KAISHA, Toyota-shi Aichi-ken (JP)

(72) Inventors: Miki Nomoto, Nagoya-shi Aichi-ken (JP); Yuka Nishiyama, Toyota-shi Aichi-ken (JP); Kenichi Okumura, Gotemba-shi Shizuok-ken (JP); Ryota Tomizawa, Mishima-shi Shizuoka-ken (JP); Tatsuya Sugano, Sunto-gun Shizuoka-ken (JP); Yushi Seki, Ashigarakami-gun Kanagawa-ken (JP); Tokuhiro Masui, Nagoya-shi Aichi-ken (JP)

(73) Assignee: TOYOTA JIDOSHA KABUSHIKI KAISHA, Toyota-shi Aichi-ken (JP)

(21) Appl. No.: 18/131,593

(22) Filed: Apr. 6, 2023

(30) Foreign Application Priority Data
Apr. 18, 2022 (JP) 2022-068448

(51) Int. Cl. G01C 21/34; B60W 60/00; G01C 21/36

(52) U.S. Cl. CPC G01C 21/3461; B60W 60/001; G01C 21/362

(57) ABSTRACT

A method for proposing to a user a movement plan using a mobile vehicle with an equipment for web meeting is provided. The method comprising the steps of: acquiring user schedule information including a movement from a first point to a second point and a participation in a web meeting before and after the movement; acquiring communication level information in an area including a road from the first point to the second point; generating a candidate of the movement plan, the candidate including a candidate that prohibits the mobile vehicle from being located in a communication district having a communication level lower than a threshold in a time zone scheduled to participate in the web meeting; and transmitting the candidate to a terminal of the user.

### CROSS-REFERENCE TO RELATED APPLICATION

The present application claims priority under 35 U.S.C. §119 to Japanese Patent Application No. 2022-68448, filed on Apr. 18, 2022, the contents of which application are incorporated herein by reference in their entirety.

### TECHNICAL FIELD

The present disclosure relates to a method and apparatus for proposing to a user a movement plan using a mobile vehicle having an equipment for a web meeting, and a system for controlling the mobile vehicle in accordance with the movement plan.

### BACKGROUND

JP2008-236381A discloses an apparatus for generating a route from a departure point to a destination point. This conventional apparatus generates a plurality of route candidates selectable by a user based on information on the departure and destination points of the user. The plurality of route candidates includes candidates that can use an optimal communication line during movement from the departure point to the destination point. JP2008-236381A also states that the plurality of route candidates may be generated by a car navigation system. In other words, JP2008-236381A states that movement means from the departure point to the destination point may be a vehicle equipped with this car navigation system.

According to the device in JP2008-236381A, when the user travels a route from the departure point to the destination point by a vehicle, the user can select from the plurality of route candidates one route that can use an optimum communication line. Therefore, for example, when the communication line is scheduled to be used by data communication or the like, it is expected that this candidate will be selected by the user.

However, it is also expected that the route that can use the optimum communication line partially includes a road having low communication quality. Here, it is disadvantageous for the user that a time zone passing through the road with low communication quality overlaps with an estimated time zone of the data communication. In particular, when the data communication is a web meeting, a decrease in communication quality leads to stress on conference participants. Therefore, if there is such disadvantage information, it is desirable to notify the user in advance.

Consider a case where the data communication is a web meeting, and the user is notified of the disadvantage information. In this case, the user is implicitly expected to change the estimated time zone of the web meeting to avoid the time zone where the disadvantage occurs. However, changing the estimated period requires readjustment of the user’s schedule as well as that of other meeting participants. Then, the notification of the disadvantage information to the user leads to that the user does not finally select the route that can use the optimal communication line, and thus the generation of the route becomes useless.

An object of the present disclosure is to provide a technique for proposing a movement plan which is useful for a user who is scheduled to participate in a movement from a departure point to a destination point and a web meeting before and after the movement and which is easily accepted by the user.

### SUMMARY

A first aspect of the present disclosure is a method for proposing to a user a movement plan using a mobile vehicle having an equipment for web meeting and has the following features.

The method comprising the steps of:
acquiring information of a schedule of the user including a movement from a first point to a second point and participation in a web meeting before and after the movement from the first point to the second point;
acquiring information of a communication level in a region including a road from the first point to the second point;
generating a candidate of the movement plan for performing a movement from the first point to the second point by the mobile vehicle based on the schedule information and the communication level information, wherein the candidate of the movement plan includes a candidate for prohibiting the mobile vehicle from being located in a communication district having a communication level lower than a threshold in a time zone scheduled to participate in the web meeting; and
sending the candidate of the movement plan to a terminal of the user.

A second aspect of the present disclosure further includes the following features in the first aspect.

The mobile vehicle further includes an equipment for desk work.

The schedule further includes an implementation of desk work before and after the movement from the first point to the second point.

The candidate of movement plan includes a candidate in which the mobile vehicle is allowed to be located in a communication district having a communication level lower than the threshold in a time zone in which the desk work is scheduled to be performed.

A third aspect of the present disclosure further includes the following features in the first aspect.

The mobile vehicle further includes an equipment for desk work.

The schedule further includes implementation of desk work before and after the movement from the first point to the second point.

The candidate of movement plan includes a candidate for prohibiting the mobile vehicle from being located in a communication district having a communication level higher than the threshold in a time zone in which the desk work is scheduled to be performed.

A fourth aspect of the present disclosure further has the following feature the first aspect.

The step of generating the candidate of the movement plan comprises the steps of:
determining whether a candidate located in a communication district in which the mobile vehicle has a communication level higher than the threshold in an original time zone scheduled to participate in the web meeting is extracted;
when it is determined that the candidate is not extracted in the original time zone, changing the original time zone and determining whether a candidate located in a communication district in which the mobile vehicle has a communication level higher than the threshold is extracted in the changed time zone; and
generating a candidate in which the mobile vehicle is prohibited from being located in a communication district having a communication level lower than the threshold in the changed time zone when it is determined that the candidate is extracted in the changed time zone.

In the step of sending the candidate of the movement plan to the terminal of the user, proposing to the user a change of the original time zone.

A fifth aspect of the present disclosure is an apparatus for proposing a movement plan using a mobile vehicle having an equipment for a web meeting to a user, and has the following features.

The apparatus includes a memory in which various information is stored and a processor which is configured to process the various information.

The various information includes information on a schedule of the user including a movement from a first point to a second point and participation in a web meeting before and after the movement from the first point to the second point, and information on a communication level in a region including a road from the first point to the second point.

The processor is configured to generate a candidate of the movement plan when movement from the first point to the second point is performed by the mobile vehicle based on the information of the schedule and the information of the communication level. The candidate of movement plan includes a candidate in which the mobile vehicle is prohibited from being located in a communication district having a communication level lower than a threshold in a time zone scheduled to participate in the web meeting.

The processor is further configured to send the candidate of the movement plan to a terminal of the user.

A sixth aspect of the present disclosure is a movement system having the following features.

The movement system includes a mobile vehicle and a management server. The mobile vehicle includes an equipment for web meeting, a driving device, and a travel control device. The management server includes a memory in which various information is stored and a processor configured to process the various information. The management server is configured to propose to the user a movement plan using the mobile vehicle.

The various information includes information on a schedule of the user including a movement from a first point to a second point and participation in a web meeting before and after the movement from the first point to the second point, and information on a communication level in a region including a road from the first point to the second point.

The processor is configured to generate a candidate of the movement plan when movement from the first point to the second point is performed by the mobile vehicle based on the information of the schedule and the information of the communication level. The candidate of movement plan includes a candidate in which the mobile vehicle is prohibited from being located in a communication district having a communication level lower than a threshold in a time zone scheduled to participate in the web meeting.

The processor is further configured to send the candidate of the movement plan to a terminal of the user.

When the candidate of the movement plan is accepted by the user, the processor is further configured to send movement plan information generated based on the candidate of the movement plan to the mobile vehicle.

The travel control device is configured to control the driving device based on the movement plan information.

According to the first or fifth aspect, when the movement from the first point to the second point is scheduled and the participation in the web meeting before and after the movement is scheduled, it is possible to propose to the user the candidate of the movement plan that realizes the participation in the web meeting during the movement by the mobile vehicle. The candidate includes a candidate in which the mobile vehicle is prohibited from being located in a communication district having a communication level lower than a threshold in a time zone scheduled to participate in the web meeting. Therefore, consideration is given so as not to fall into a situation in which the data communication environment deteriorates in the time zone in which the participation in the web meeting is scheduled. Therefore, according to the first or fifth aspect, it is possible to propose a movement plan which is beneficial to the user who is scheduled to participate in the movement from the first point to the second point and the web meeting before and after the movement and which is easily accepted by the user.

According to the second or third aspect, when the desk work is scheduled to be performed before and after the movement from the first point to the second point, it is possible to propose to the user the candidate of the movement plan for realizing the desk work in a room of the mobile vehicle.

According to the fourth aspect, when the candidate of the movement plan that realizes participation in the web meeting is not extracted in the original time zone in which the participation in the web meeting is scheduled, it is possible to propose to the user the candidate of the movement plan in which the time zone is changed.

According to the sixth aspect, when the candidate of the movement plan is accepted by the user, it is possible to realize the participation in the web meeting without stress during the movement by the mobile vehicle.

### BRIEF DESCRIPTION OF THE DRAWINGS

FIG. 1 is a diagram illustrating an outline of a first embodiment;

FIG. 2 is a diagram showing an example of a candidate of a movement plan generated in a management server in a schedule format;

FIG. 3 is a diagram illustrating an example of the candidate of the movement plan in which communication level information is taken into consideration;

FIG. 4 is a diagram illustrating another example of the candidate of the movement plan in which the communication level information is taken into consideration;

FIG. 5 is a diagram illustrating a configuration example of the management server;

FIG. 6 is a block diagram illustrating a configuration example of a mobile vehicle;

FIG. 7 is a flowchart illustrating an example of processing performed by an information processing device (a processor) of the management server;

FIG. 8 is a diagram illustrating an outline of a second embodiment;

FIG. 9 is a diagram illustrating an example of the candidate of the movement plan generated in the second embodiment;

FIG. 10 is a diagram illustrating another example of the candidate of the movement plan generated in the second embodiment; and

FIG. 11 is a flow chart illustrating an example of processing performed by the information processing device (the processor) of the management server.

### DESCRITION OF EMBODIMENT

Hereinafter, a movement plan proposal method, a movement plan proposal device, and a movement system according to embodiments of the present disclosure will be described with reference to the drawings. The proposal method according to the embodiment is realized by computer processing performed by a management server as a proposal device according to the embodiments. In the drawings, the same or corresponding parts are denoted by the same reference numerals, and the description thereof will be simplified or omitted.

### 1. First Embodiment

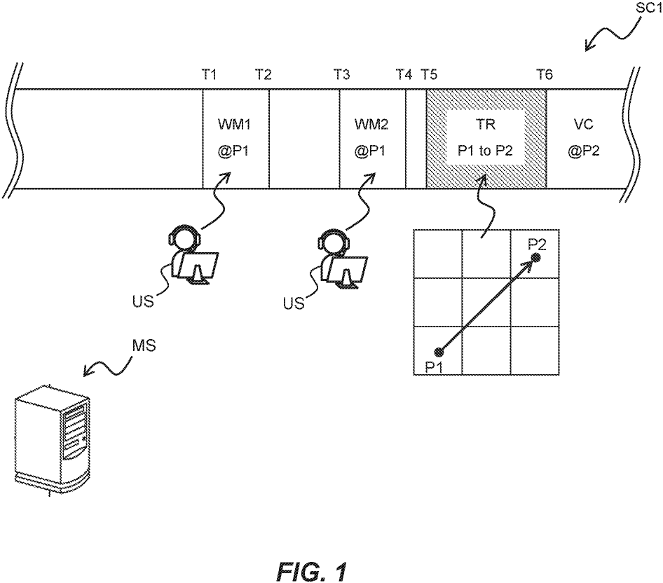

A first embodiment of the present disclosure will now be described with reference to FIGS. 1-7.

### 1-1. Outline

FIG. 1 is a diagram illustrating an outline of the first embodiment. FIG. 1 shows an example of a schedule SC1 of a user US. The schedule SC1 is, for example, a schedule of one day (e.g., Friday) of the user US. However, the schedule SC1 may be a schedule across dates (e.g., two days of Friday and Saturday). It is assumed that information on the schedule SC1 (hereinafter, also referred to as “schedule information SCH”) is grasped by a management server MS before the previous day (e.g., Thursday).

In the example shown in FIG. 1, a web meeting WM1 is scheduled in a time zone from time T1 to T2. A web meeting WM2 is scheduled in a time zone from time T3 to T4. In the web meetings WM1 and WM2, a communication terminal such as a personal computer, a smartphone, and a tablet terminal are used to perform a communication with remote parties via applications or web browsers. Examples of the web meetings WM1 and WM2 include a meeting with a remote party, a seminar, and a workshop.

The web meetings WM1 and WM2 are scheduled to take place at a first point P1. The point P1 is typically a workplace or a home of the user US. However, even a base other than the workplace and the home (e.g., a base outside the home) can be a candidate of the point P1 as long as the base includes an equipment for a web meeting such as an information processing device and a camera. In addition, when the user US carries a communication device and plans to participate in the web meetings WM1 and WM2 using the communication device, if a location is provided with communication equipment as the equipment for web meeting, the location can be the candidate for the point P1.

It is not necessary for the management server MS to grasp the information that a participating base for the web meetings WM1 and MW2 is the point P1. Furthermore, this information may not be included in the schedule SC1. In other words, it is sufficient for the management server MS to grasp at least the time zones scheduled to participate the web meetings WM1 and WM2, and the information on the participating base for the web meetings is arbitrary information.

In the example shown in FIG. 1, a trip TR from the point P1 to a point (a second point) P2 is scheduled from a time zone from time T5 to T6. The point P2 is not particularly limited as long as it is a point away from the point P1. For example, when the point P1 is the home of the user US, the point P2 is a remote place other than the home, and when the point P1 is the workplace of the user US, the point P2 is a remote place other than the workplace. In the example illustrated in FIG. 1, it is assumed that a vacation VC after the time T4 (or the time T5) is scheduled, and the point P2 is a travel destination base (e.g., an accommodation hotel).

The point P1 corresponds to a departure point in the trip TR, and the point P2 corresponds to a destination point in the trip TR. In the time zone from time T5 to T6, information indicating that trip TR is performed from the point P1 to the point P2 and positional information on the points P1 and P2 are grasped by the management server MS.

### 1-2. Movement Plan

As described above, the schedule SC1 includes of web meeting WM1 and WM2, and trip TR from the point P1 to the point P2. As described in the description of the point P1, the participation in the web meeting is possible with an equipment for the web meeting. Therefore, in the first embodiment, a mobile vehicle MB having the equipment for the web meeting is considered. During the trip TR from the point P1 to the point P2 using the mobile vehicle MB, the management server MS generates candidates of a movement plan that realizes participation in the web meetings WM1 and WM2.

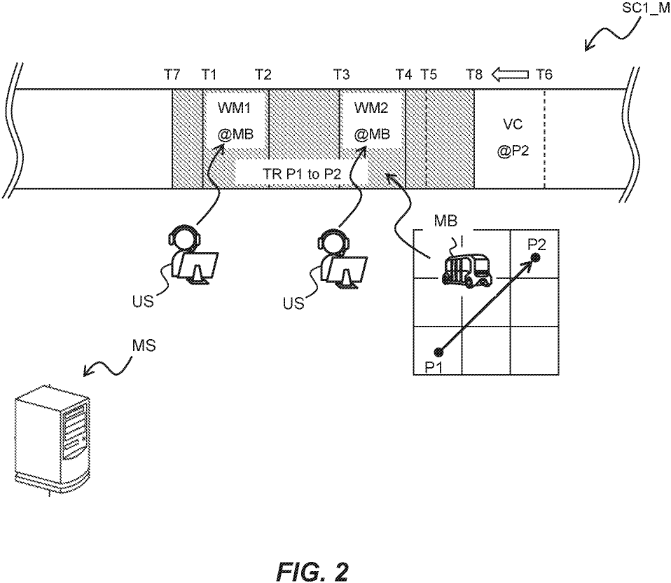

FIG. 2 shows an example of a schedule SC1_M generated in the management server MS. It should be noted that the schedule SC1_M is one of the candidates of the movement plans generated in the management server MS, which is subjected to the candidates of the movement plan. In the example shown in FIG. 2, the user US gets on the mobile vehicle MB at time T7 before the time T1. The pickup location of the user US is the point P1. Further, the user US gets out of the mobile vehicle MB at time T8 after the time T4. A drop-off location of the user US is the point P2. That is, during the period from the time T7 to the time T8, the user US performs the trip TR from the point P1 to the point P2 using the mobile vehicle MB.

In the example shown in FIG. 2, the participation in the web meetings WM1 and WM2 is performed using the equipment for the web conferencing of the mobile vehicle MB. Therefore, according to the example shown in FIG. 2, it is possible to reach the point P2 earlier time (e.g., the time T8) than the case where the user departs the point P1 after the end time (the time T4) of the web meeting WM2 (i.e., the example shown in FIG. 1). Here, a time availability gives a psychological margin to the user US. Therefore, the schedule SC1_M is beneficial to the user US, which is considered to be acceptable to the user US.

In particular, when the vacation VC after the time T4 (or the time T5) is scheduled, the earlier arrival time at the point P2 leads to an extension of a stay time at the travel destination. Therefore, when the vacation VC is scheduled after the trip TR to the point P2, the schedule SC1_M is considered to be beneficial to the user US who desires to fully enjoy the trip.

Also, although the schedule SC1_M described in FIG. 2 is for an outbound route, this schedule SC1_M can also be applied to an inbound route. For example, in the description of FIG. 1, it is assumed that the point P1 is the base of the travel destination (e.g., the accommodation hotel) and the point P2 is the place of work or the home of the user US. It is also assumed that the same web meetings WM1 and WM2 are scheduled as in the example shown in FIG. 1. Then, when the schedule SC1_M is applied to the inbound route, it is possible to comply with the time that the user US must arrive at point P2 and still be able to complete participation in the web meetings WM1 and WM2 before arriving at the point P2. This makes it possible to delay the departure time from the point P1 from the initial schedule, leading to a further extension of the stay time at the travel destination. Therefore, it is considered that applying the schedule SC1_M to the outbound and inbound routes is particularly beneficial to the user US who desires to fully enjoy the travel.

However, a bottleneck in such the schedule SC1_M is a data communication environment during the movement. This is because, if the user US moves through an area where the infrastructure for data communication is insufficient during a time zone in which the user US is scheduled to participate in the web meetings WM1 and WM2, the user US suffers a disadvantage. Therefore, in the first embodiment, when the candidate of the movement plan is generated, information (hereinafter, also referred to as “communication level information CLV”) of the communication level CLs in the area AR including the road from the pint P1 to the point P2 is considered.

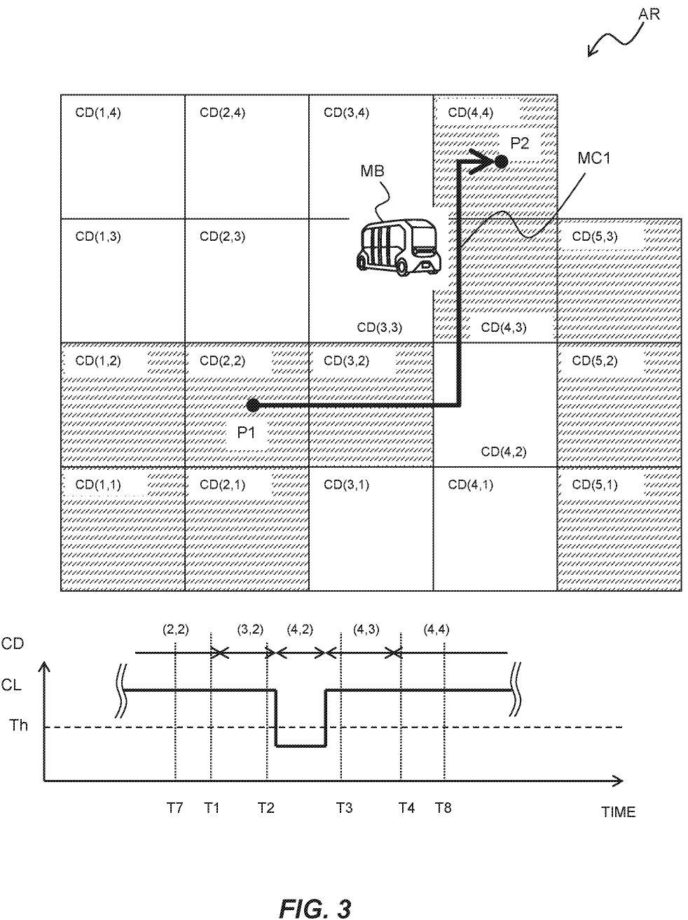

FIG. 3 is a diagram illustrating an example of the candidate of the movement plan in which the communication level information CLV is taken into consideration. In the example shown in FIG. 3, an example of the area AR including the road from the point P1 to the point P2 is shown. The road from the point P1 to the point P2 is a road on which the mobile vehicle MB can travel. Examples of this road include a road for a vehicle stored in a database of a general car navigation system. In the first embodiment, candidates for the route from the point P1 to the point P2 are generated using known techniques. At least one candidate of the route from the point P1 to the point P2 is generated.

In the first embodiment, the area AR is further divided into a plurality of communication district CDs. In the example shown in FIG. 3, the area AR is divided into meshes, and a communication level CL is set for each communication district CD. The communication level CL can be set based on, for example, a combination of a history of data (for example, reception strength of radio waves, latency, throughput, or the like) related to communication quality during traveling of a dedicated mobile vehicle whose communication quality is to be measured and a history of location data of the mobile vehicle. The history of the data related to the communication quality may be pre-processed using a temporal element such as a day of the week (weekday, holiday, or the like) or a time zone (morning, afternoon, or night). It is desirable that the specifications of the communication equipment included in the measurement-dedicated mobile vehicle are equivalent to those of the mobile vehicle MB.

In the first embodiment, the communication level CL is set in at least two stages. When the communication level CL of two stages is set, for example, the communication level CL is composed of a communication level (a high communication level) at which the user can participate in the web meeting without any problem and a communication level (a low communication level) at which the user cannot participate in the web meeting. When the communication level CL of three stages is set, the latter communication level (i.e., the low communication level) is subdivided into a communication level (a medium communication level) at which a simple data communication can be performed without any problem and a communication level (a low communication level) at which the simple data communication is not performed.

In the first embodiment, a threshold Th of the communication level CL is further set. The management server MS applies this threshold Th to the candidate of the route from the point P1 to the point P2 and sets the candidate of the movement plan. The communication district CD (2,2), CD (3,2), CD (4,3) and CD (4,4) shown in FIG. 3 are examples of the communication district CDs having the communication level CL higher than the threshold Th. On the other hand, the communication district CD (3, 1), CD (4, 1), and CD (4, 2) are examples of the communication district CDs having the communication level CL equal to or less than the threshold Th.

The candidate of the movement plan MC1 is depicted in FIG. 3. This candidate MC1 is the candidate MC to pass through the communication district CDs (2,2), (3,2), (4,2), (4,3) and (4,4). The transition of the communication level CL when the mobile vehicle MB moves in accordance with the candidate MC1 is shown in the lower part of FIG. 3. As understood from the lower part, the communication level CL is lower than the threshold Th during the time zone to pass through the communication district CD (4, 2). The communication level CL exceeds the threshold Th during the time zone to pass through the other communication district CDs (such as the communication district (2, 2)).

That is, the candidate MC1 is the candidate generated by prohibiting the mobile vehicle MB from being located in the communication district CD having the communication level CL lower than the threshold Th in the time zones scheduled to participate in the web meetings WM1 and WM2 (i.e., from the time T1 to the time T2 and from the time T3 to the time T4). The candidate MC1 may be the candidate generated by allowing the mobile vehicle MB to be located in the communication district having the communication level less than the threshold Th in time zone other than these time zones. By generating such the candidate MC1, the schedule SC1_M described with reference to FIG. 2 can be realized.

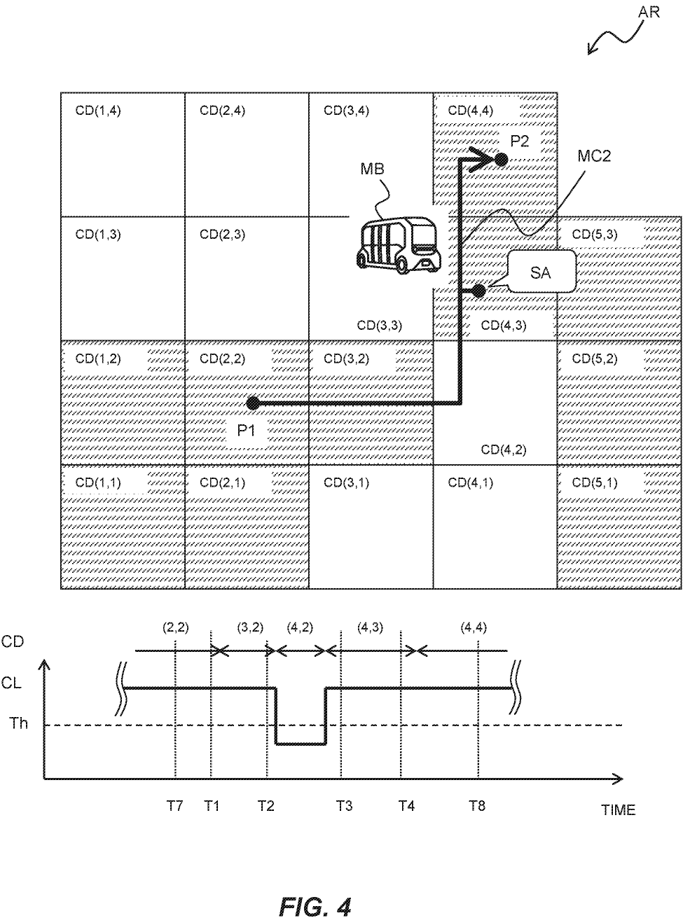

FIG. 4 is a diagram illustrating another example of the candidate of the movement plan in which the communication level information CLV is taken into consideration. In the example shown in FIG. 3, communication the candidate of the route from the point P1 to the point P2 is generated, the communication bases existing on the route are not considered. On the other hand, in the example shown in FIG. 4, positional information of a service area SA (or a rest spot) existing in the communication district CD (4, 3) is taken into consideration. The candidate of the movement plan MC2 depicted in FIG. 4 is the candidate to stop at the service area SA in the middle of the trip TR from the point P1 to the point P2. It is assumed that the communication level CL in the service area SA exceeds the threshold Th.

In the candidate MC2, the mobile vehicle MB arrives at the service area SA before the time zone (i.e., the time T3 to the time T4) scheduled to participate in the web meeting WM2. Then, after this time zone has elapsed, the mobile vehicle MB leaves the service area SA. That is, in the candidate MC2, the mobile vehicle MB stays in the time zone during which the user is scheduled to participate in the web meeting WM2. When staying in the service area SA, there is a possibility that the arrival time (time T8) at the point P2 will be later than that shown in FIG. 3. However, it is expected that data communication will be stable by staying in the service area SA over the time zone in which the participation in the web meeting WM2 is scheduled. Therefore, according to such the candidate MC2, as well as the candidate MC1, it is possible to realize the schedule SC1_M described in FIG. 2

### 1-3. Example of System Configuration

Next, configuration examples of the movement plan proposal system and the movement system according to the first embodiment will be described.

### 11. Configuration Example of Management Server MS

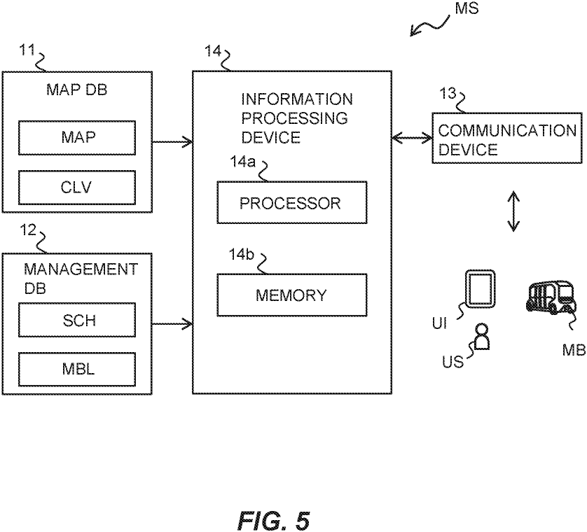

FIG. 5 is a diagram illustrating the configuration example of the management server MS. The configuration example shown in FIG. 5 includes a map DB (database) 11, a management DB12, a communication device 13, and an information processing device 14.

In the map DB11, map information MAP and communication level information CLV are stored. Examples of the map information MAP include information on positions of roads, information on road shapes (e.g., types of a curve and a straight line), and information on positions of intersections and constructions. The map information MAP may include positional information on public communication facilities (e.g., the service area SA). The map information MAP may include information on road surface shape of the roads (e.g., information on presence or absence of unevenness). The communication level information CLV is as described in FIG. 3. The map DB11 is formed in a predetermined memory device (e.g., a nonvolatile recording media such as a hard disk and a flash memory).

Like the map DB11, the management DB12 is formed in a predetermined memory device. The schedule information SCH is stored in the management DB12. The schedule information SCH includes information on a schedule of the user US in a certain period (e.g., from next day to the day one month ahead). The schedule information SCH is periodically acquired from a user interface UI (e.g., a communication terminal carried by the user US). When there are a plurality of users US, the schedule information SCH is stored for each user US.

In the management DB12, mobile vehicle information MBL is also stored. The mobile vehicle information MBL is information to identify the mobile vehicle MB. The mobile vehicle MB may be owned by the user US or may be used for sharing purposes such as a rental car. The mobile vehicle information MBL includes various information related to the mobile vehicle MB such as positional information on the mobile vehicle MB, specification information on communication equipment included in the mobile vehicle MB, and the movement plan information. Note that the movement plan information is generated when the candidate of the movement plan MC is accepted by the user US.

The communication device 13 is connected to an external device via a communication line network. The communication line network is not particularly limited, and a wired or wireless network can be used. Examples of the communication line network include an Internet line, a world wide web (WWW), a telephone line, a local area network (LAN), a storage area network (SAN), and a delay tolerant network (DTN). Examples of the wireless communication include Wi-Fi (Wireless Fidelity) and Bluetooth (registered trademark). The wireless communication may be a mode in which the management server MS performs direct communication (Ad Hoc communication) or may be indirect communication via an access point. The communication destination of the communication device 13 includes the mobile vehicle MB and the user interface UI. In communication with the mobile vehicle MB, the communication device 13 transmits, for example, travel schedule information to the mobile vehicle MB. In the communication with the user interface UI, the communication device 13 transmits, for example, information on the candidate of the movement plan MC to the user interface UI.

The information processing device 14 is a computer for processing various information related to generation of the candidate of the movement plan MC, proposal of the candidate MC to the user US, and management of the mobile vehicle MB (the management of an operation according to the movement plan). The information processing device 14 includes at least one processor 14a and at least one memory 14b. The processor 14a includes a CPU (Central Processing Unit). The memory 14b is a volatile memory such as a DDR memory, and develops various programs used by the processor 14a and temporarily stores various information.

The processor 14a executes a program stored in the memory 14b to perform processing related to the generation of the candidate of the movement plan MC and the proposal to the user US. The processor 14a executes the program stored in the memory 27b to perform processing related to the management of the mobile vehicle MB in accordance with the movement plan (the management of the operation in accordance with the movement plan). An example of processing performed by the processor 14a will be described later.

### 12. Configuration Example of Mobile Vehicle MB

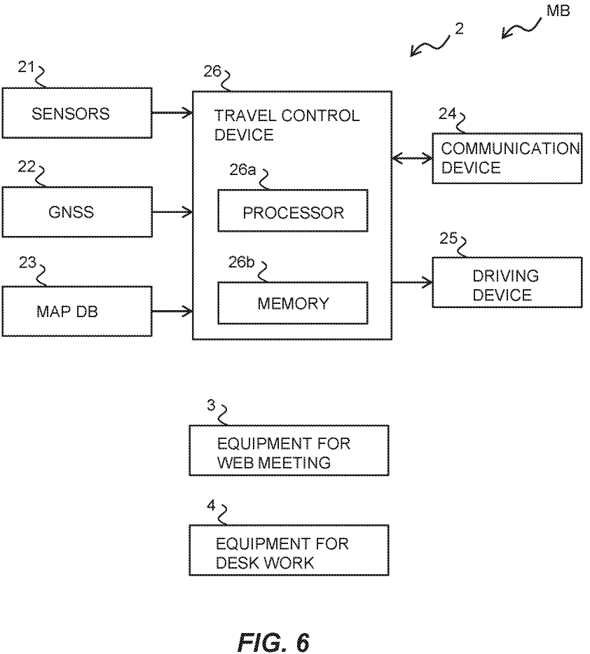

FIG. 6 is a block diagram illustrating a configuration example of the mobile vehicle MB. The configuration example shown in FIG. 6 includes an equipment for movement 2, an equipment for web meeting 3, and an equipment for desk work 4.

The equipment for movement 2 is an equipment for causing the mobile vehicle MB to autonomously drive or to travel based on the remote assistance. In the example shown in FIG. 6, the equipment for movement 2 includes sensors 21, a global navigation satellite system (GNSS) receiver 22, a map DB23, a communication device 24, a driving device 25, and a travel control device 26. The constituent elements such as the sensors 21 and the travel control device 26 are connected by, for example, a predetermined network (e.g., a controller area network (CAN)).

Examples of the sensors 21 include a surrounding circumstances sensor and a vehicle body state sensor. The surrounding surroundings sensor detects a surrounding situation of the mobile vehicle MB. The surrounding circumferences sensor includes a camera. The camera images the surroundings of the mobile vehicle MB. The surrounding circumferences sensor may also include a LiDAR (Laser Imaging Detection and Ranging) or a radar. The vehicle body state sensor detects a state of the mobile vehicle MB. The state of the mobile vehicle MB includes speed, acceleration, steering angle, yaw rate, and the like of the mobile vehicle MB. The sensors 21 further include a sensor for detecting the remaining amount of a battery mounted on the mobile vehicle MB. The sensors 23 transmit various information on the mobile vehicle MB to the travel control device 26.

The GNSS receiver 22 is a device that receives signals from three or more satellites. The GNSS receiver 22 acquires the positional information on the mobile vehicle MB. The GNSS receiver 22 may calculate an attitude (a direction) of the mobile vehicle MB based on the acquired positional information. The GNSS receiver 22 transmits the positional information and the attitude information to the travel control device 26.

The map DB23 stores map information. Examples of the map information stored in the map DB23 is the same as the map information MAP stored in the map DB11. The map DB23 may not be provided in the mobile vehicle MB. In this case, the mobile vehicle MB may acquire the map information around the actual position of the mobile vehicle MB from an external server (e.g., the management server MS).

The communication device 24 wirelessly communicates with a base station of a wireless network. Examples of a communication standard of the wireless communication include a standard of mobile vehicle communication such as 4G, LTE, or 5G. The connection point of the communication device 24 includes at least the management server MS. In communication with the management server MS, the communication device 24 sends at least the positional information of the mobile vehicle MB received from the travel control device 26 to the management server MS.

The connection point of the communication device 24 may include the user interface UI. In the communication with the user interface UI, the communication device 24 may send the positional information of the mobile vehicle MB to the user interface UI. When the mobile vehicle MB is used for sharing, the communication device 24 may transmit ID information on the mobile vehicle MB to the user interface UI.

When the mobile vehicle MB is assisted by the remote assistance, a remote assistance device (not shown) may be included in the connection point of the communication device 24. In the communication with the remote assistance device, the communication device 24 may transmit at least the surrounding image information on the mobile vehicle MB to the remote assistance device in addition to the positional information on the mobile vehicle MB received from the travel control device 26. The communication device 24 may also receive remote assistance information from a remote assistance device. The remote assistance information is information to perform the remote assistance of the mobile vehicle MB.

The driving device 25 includes a device for accelerating, decelerating, and steering the mobile vehicle MB. The driving device 25 includes, for example, a driving device, a steering device, and a brake device. The driving device drives tires of the mobile vehicle MB. The steering device steers the tires of the mobile vehicle MB. The brake device applies a braking force to the mobile vehicle MB. The acceleration of the mobile vehicle MB is performed by control of the driving device. The deceleration of the mobile vehicle MB is performed by control of the brake device. When the driving device is a motor, braking of the mobile vehicle MB may be performed using regenerative braking by control of the motor. The steering of the mobile vehicle MB is performed by control of the steering device.

The travel control device 26 is a computer for processing various information acquired by the mobile vehicle MB. The travel control device 26 includes at least one processor 26a and at least one memory 26b. The processor 26a includes the CPU. The memory 26b develops various programs used by the processor 26a and temporarily stores various information. The various information acquired by the travel control device 26 is stored in the memory 26b.

The processor 26a performs various types of control related to autonomous driving of the mobile vehicle MB by executing the program stored in the memory 26b. When the movement plan information is received, the processor 26a controls the driving device 25 such that the mobile vehicle MB automatically travels along the route included in the movement plan information. The processor 26a also determines whether the remote assistance is required by executing the program stored in the memory 26b. If it is determined that remote assistance is required, the processor 26a generates a remote assistance request and transmits it to the remote assistance device via the communication device 24.

The equipment for the web meeting 3 includes a communication equipment and a computer including a camera, a microphone, a speaker, a display, and a processing device. Typically, the computer constituting the equipment for web meeting 3 is a personal computer, a smartphone, or a tablet terminal in which a program for the web meeting is installed. When the user US carries such the communication terminal, in-vehicle communication equipment that communicates with the communication terminal in a wired or wireless manner corresponds to the equipment for web meeting 3.

The equipment for desk work 4 includes elements (furniture) for performing desk work such as a desk, a chair, and a lighting. The equipment for desk work 4 is installed in one corner of a room of the mobile vehicle MB. The function and layout of the elements constituting the equipment for desk work 4 are not particularly limited. The equipment for desk work 4 is used, for example, during the web meeting used by the equipment for web meeting 3. The equipment for desk work 4 may be used during a local work accompanied by data communication other than the web meeting. The equipment for desk work 4 may be used for a local work without data communication.

### 1-4. Processing Example Executed by Management Server MS

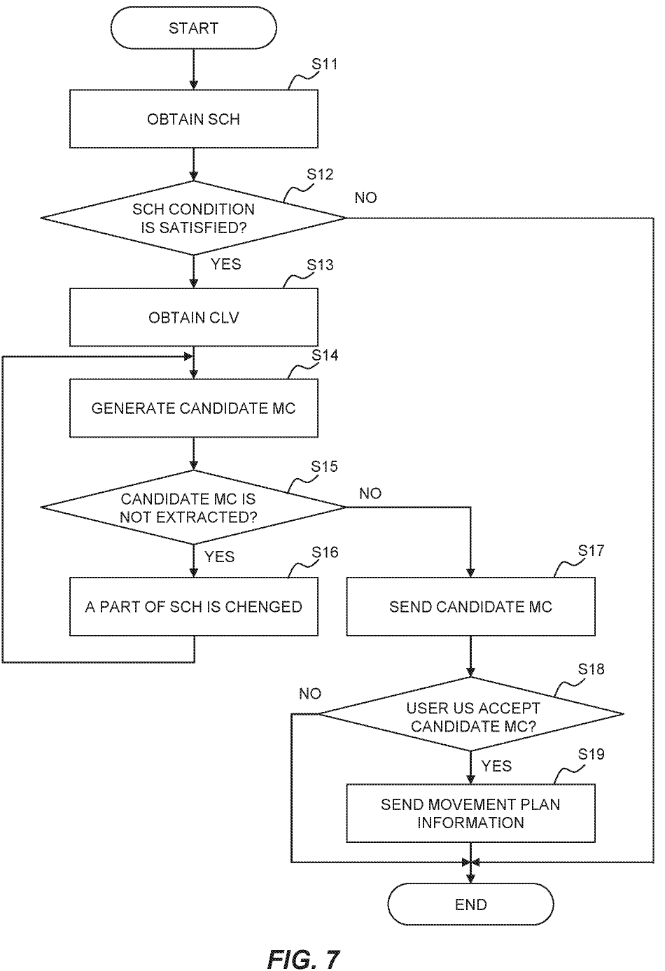

FIG. 7 is a flow chart illustrating an example of processing performed by the information processing device 14 (the processor 14a) of the management server MS. The routine shown in FIG. 7 is repeatedly executed at a predetermined control cycle, for example.

In the routine shown in FIG. 7, first, the schedule information SCH is acquired (step S11). As described above, the schedule information SCH is the information stored in the management DB12, and includes information on the schedule of the user US in the certain period (e.g., from the next day to one month ahead). When there are a plurality of users US, the processing of step S11 and subsequent steps is performed for each user US.

Following the processing of step S11, it is determined whether SCH condition is satisfied (step S12). The SCH condition is a condition for determining whether the generation of the candidate of the movement plan MC is needed. Whether or not the SCH condition is satisfied is determined based on the schedule information SCH acquired in step S11. For example, when the trip TR from the point P1 to the point P2 is scheduled and the participation in the web meeting before and after the trip TR is scheduled, it is determined that the SCH condition is satisfied.

“Before and after the trip TR” is determined based on the time at which the trip TR is scheduled to start or end. Several hours to ten hours before the time at which the trip TR is scheduled to start is an example of “before trip TR”. Several hours to ten and several hours after the scheduled end time of the trip TR is an example of “after trip TR”. The interval of several hours to several tens of hours is an example, and “before and after trip TR” may be determined at an interval of several tens of minutes to one hour. When the determination result of step S12 is negative, it is determined that there is no need to generate the candidate of the movement plan MC, and thus the current processing ends.

When the determination result in step S12 is positive, the communication level information CLV is acquired (step S13). The communication level information CLV is acquired based on the positional information of the points P1 and P2 included in the schedule information acquired in step S11. For example, the area AR including the road from the point P1 to P2 is specified. The area AR is specified by, for example, generating at least one candidate of the route from the point P1 to the point P2 and extracting an area on the map including the at least one candidate of the route. When the area AR is specified, the map DB11 is referred to using the positional information on the area AR. Accordingly, information of each communication level CL (i.e., the communication level information CLV) of the communication district CD included in the area AR is acquired.

When generating the candidate of the route, it is desirable to generate the candidate of the route passing through a smooth road with less unevenness based on the information on the road surface shape included in the map information MAP. Since the candidate of the route passing through the smooth road is generated, the indoor quietness during the web meeting is secured. If the road passing through the time zone scheduled to participate in the web meeting is at least the smooth road, it can be expected to ensure the indoor quietness during the web meeting.

Following the processing of step S13, the candidate of the movement plan MC is generated (step S14). In the generation of the candidate MC, for example, on the assumption that the mobile vehicle MB continues to move at a legal speed (or a constant speed lower than the legal speed) along the candidate of at least one route described above, the mobile vehicle MB is predicted to pass through time zone in each communication district CD. Since the information on the respective communication level CLs of the communication district CDs has been acquired in the processing in step S13, when the time zone to pass through the respective communication district CDs is predicted, the respective communication level CLs in the predicted time zone is specified.

Subsequently, each communication level CL in the predicted time zone is compared with the time zone scheduled to participate in the web meeting, and the candidate of the route in which the mobile vehicle MB is located in the communication district CD having a high communication level in the time zone scheduled to participate in the web meeting is extracted. When such the candidate of the route (hereinafter also referred to as a “desired route candidate”) is extracted, the extracted desired route candidate and the predicted time zone to pass through each communication district CD are combined to generate the candidate of the movement plan MC.

When the desired route candidate is extracted, the predicted time zone to pass through the communication district CD may be corrected such that the mobile vehicle MB is located in a single communication district CD in the time zone scheduled to participate in the web meeting. If the candidate of the route after the predicted time zone to pass through is modified still corresponds to the desired route candidate, the candidate of the movement plan MC may be generated by combining the route candidate with the predicted time zone to pass through each communication district CD.

If the desired route candidate cannot be extracted, the predicted time zone to pass through may be modified to extend the stay time at the communication district CD having the high communication level. If the staying time at the communication district CD having the high communication level is extended, the predicted time zone to pass through communication district CD is shifted to the later time zone by the amount of the extended stay after passing through this communication district CD. When the desired route candidate can be extracted by performing such a correction, the route candidate and the predicted time zone to pass through each communication district CD are combined to generate the candidate of the movement plan MC. The extension of the stay time to the communication district CD having the high communication level is performed by, for example, correcting the route such that the mobile vehicle MB stops at a communication base (e.g., the service area SA described in FIG. 2) existing in the communication district CD.

The correction of the predicted time zone to pass through is repeatedly performed until the arrival time at the second point passes the original arrival time included in the schedule information SCH. Alternatively, the modification of the predicted time zone to pass through is repeatedly performed until the number of modifications to the candidate of the route to be modified reaches a predetermined number of times.

The processing of step S14 is performed only once for at least one route candidate generated when the area AR is specified. When the predicted time zone to pass through is modified, the processing of step S14 may be repeatedly performed until a predetermined time elapses or until the number of modifications to the candidate of the at least one route reaches a predetermined number.

Following the processing of step S14, it is determined whether or not the candidate MC is extracted (step S15). For example, in the processing of step S14, when the predetermined time has elapsed without the desired route candidate being extracted, a positive determination result is output in the processing of step S15. In this case, the processing of step S16 is performed.

In the processing of step S16, a part of the schedule information SCH is changed. The schedule information SCH is changed by shifting an original time zone in which the participation in the web meeting is scheduled to a later or an earlier time zone. When the processing of step S16 has been performed, the processing of step S14 is performed. Repeating the processing of steps S14 to S16 many times leads to an increase in processing load. Therefore, it is desirable to set an upper limit to the number of repetitions of the processing of step S16 for the candidate of the route that is the target of the change (e.g., two times).

When a negative determination result is output in the processing of step S15, the candidate MC generated in the processing of step S14 is send to the user US (e.g., the user interface UI) (step S17). When a plurality of the candidate MCs is generated in the processing of step S14, all of the candidate MCs are send to the user US. The candidate MC having the shortest boarding time to the mobile vehicle MB or the earliest arrival time at the second point P2 may be selected from these candidate MCs and send to the user US. When the original time zone has been changed through the processing of step S16, it is desirable that a proposal to change the schedule is send to the user US in addition to the candidate MC.

Following the processing of step S17, it is determined whether the user US has accepted the candidate MC (step S18). For example, when a consent signal is received from the user interface UI, it is determined that the user US has consented to the candidate MC. When the determination result in step S18 is negative, it is determined that candidate MC has not been adopted, and thus the current processing is terminated.

If the determination result of step S18 is positive, it is determined that the candidate MC is adopted as a final movement plan. Therefore, in this case, the movement plan information is generated from the candidate MC and send to the user US (e.g., the user interface UI) and the mobile vehicle MB (step S19). In the processing of step S19, the movement plan information is also stored in the management DB12.

### 1-5. Effect

According to the first embodiment described above, when the trip TR from the point P1 to the point P2 is scheduled and the participation in the web meeting before and after the trip TR is scheduled, the candidate of the movement plan MC that realizes the participation in the web meeting during the trip TR by the mobile vehicle MB can be proposed to the user US. This candidate MC takes into consideration the information of the communication level CL in the area AR including the road from the point P1 to the point P2, so as not to fall into a situation in which the data communication environment is deteriorated in the time zone scheduled to participate in the web meeting. Therefore, it is beneficial for the user US that the candidate MC is proposed. In addition, since the candidate MC is accepted by the user US, it is possible to realize participation in the web meeting without stress during the movement by the mobile vehicle MB, and it is also possible to quicken the arrival time at the point P2.

### 2. Second Embodiment

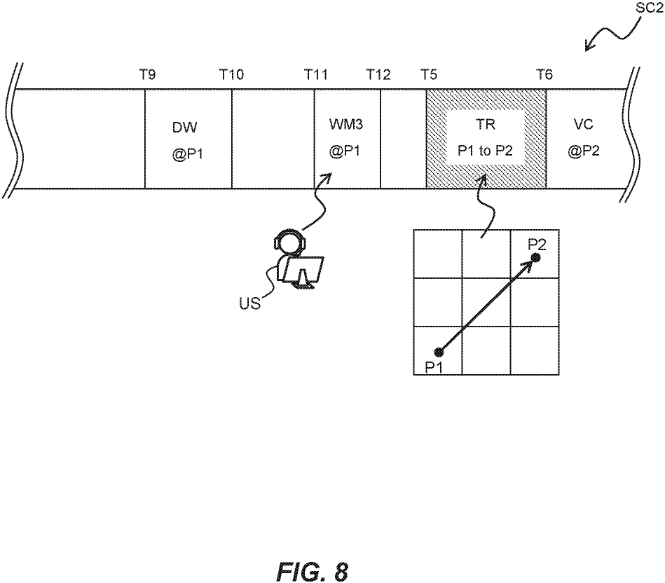

A second embodiment of the present disclosure will be described with reference to FIGS. 8 to 10. The description of the same contents as those of the first embodiment will be omitted as appropriate.

### 2-1. Outline

FIG. 8 is a diagram illustrating the outline of the second embodiment. FIG. 8 shows an example of another schedule SC2 of the user US. A part of the schedule SC2 is common to the schedule SC1 described in FIG. 1. What is different from the schedule SC1 is that the desk work DW is scheduled in a time zone from time T9 to T10 and the web meeting WM3 is scheduled in a time zone from time T11 to T12.

General desk work includes the local work with data communication other than the web meeting and the local work without data communication. Examples of the former include a work including access to a local server (e.g., a mail server). Examples of the latter include a work using an application on a personal computer. In the second embodiment, these local works are defined as desk work DW. The definition of the web meeting WM3 is the same as that of the web meetings WM1 and WM2.

### 2-2. Movement Plan

In the second embodiment, it is assumed that the user US performing the desk work DW wants to concentrate on the desk work DW. In this case, it is conceivable that the user US intentionally interrupts the data communication before the start of the desk work DW and recovers the data communication after the end of the desk work DW. That is, in this case, it is considered that the user US does not desire active data communication during the desk work DW. Therefore, in the second embodiment, the candidate of the movement plan MC is generated to pass through the communication district CD having the communication level CL lower than the threshold Th in the time zone in which the desk work DW is scheduled.

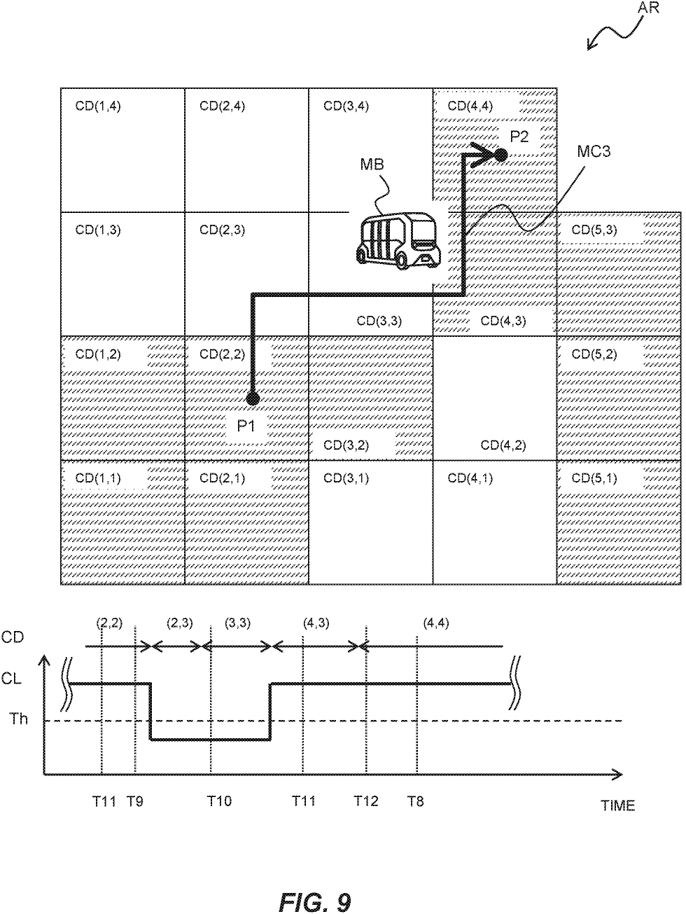

FIG. 9 is a diagram illustrating an example of the candidate of the movement plan MC generated in the second embodiment. The area AR and the plurality of communication district CDs shown in FIG. 9 are the same as those in the example shown in FIGS. 3 or 4. Similarly to the example shown in FIGS. 3 or 4, also in the example shown in FIG. 9, at least one candidate of the route from the point P1 to the point P2 is generated.

FIG. 9 shows a candidate of the movement plan MC3. This candidate MC3 is a candidate MC to pass through the communication district CDs (2,2), (2,3), (3,3), (4,3), and (4,4). The transition of the communication level CL when the mobile vehicle MB moves in accordance with the candidate MC3 is shown in the lower part of FIG. 9. As understood from the lower part, the communication level CL is lower than the threshold Th in the time zone to pass through the communication district CDs (2, 3) and (3, 3). The communication level CL exceeds the threshold Th in the time zone to pass through other communication district CDs (e.g., the communication district (2, 2)).

That is, the candidate MC3 is the candidate generated by prohibiting the mobile vehicle MB from being located in the communication district CD having the communication level WM3 lower than the threshold Th in the time zone (i.e., time T11 to T12) scheduled to participate in the web meeting zone. The candidate MC3 may also be the candidate generated by allowing the mobile vehicle MB to be located in the communication district having the communication level lower than the threshold Th in the time zone (i.e., time T9 to T10) in which the desk work DW is scheduled.

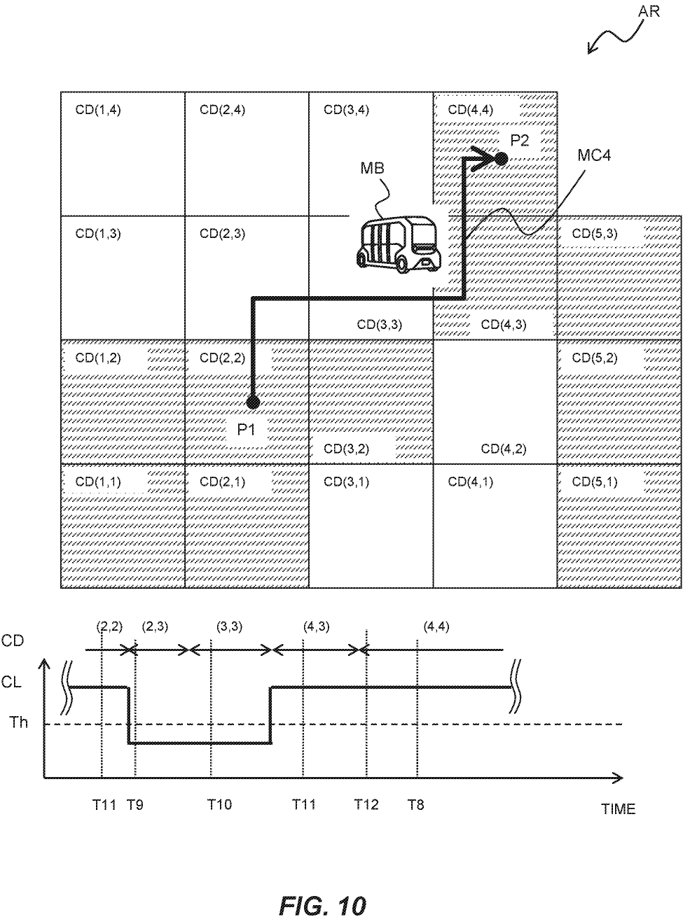

FIG. 10 is a diagram illustrating another example of the candidate of the movement plan MC generated in the second embodiment. The route from the point P1 to the point P2 of the candidate MC4 shown in FIG. 10 is the same as that of the candidate MC3 shown in FIG. 9. The difference from the candidate M3 is the transition of the communication level CL. As understood from the lower part of FIG. 10, in the candidate MC4, the communication level CL is lower than the threshold Th in the time zone in which the desk work DW is scheduled (e.g., time T9 to T10). That is, the candidate MC4 is the candidate generated by prohibiting the mobile vehicle MB from being located in the communication district having the communication level exceeding the threshold Th in the time zone in which the desk work DW is scheduled.

By generating the candidate MC3 or MC4, the same effect as the effect according to the first embodiment may be obtained. In addition, since the candidate MC3 or MC4 is generated, the desk work DW can be performed in the room of the mobile vehicle MB. The user US is expected to perform the desk work DW by using the equipment for desk work 4 shown in FIG. 6.

In the second embodiment, it is assumed that the candidate MC3 or MC4 is adopted by the user US as the final movement plan. In this case, the user US may perform the desk work DW as scheduled, and may block the data communication during performing the desk work DW. Therefore, in the second embodiment, a proposal for data communication is made to the user US before the time zone in which the desk work DW is scheduled is reached and after the time zone has elapsed.

The proposal of the data communication is made, for example, by transmitting a predetermined message from the management server MS to the user interface UI. Examples of the predetermined message include “Desk work time will start soon. It is recommended to keep data communication” and “Desk work time has ended. It is recommended to keep data communication”.

### 2-3. Processing Example Executed by Management Server MS

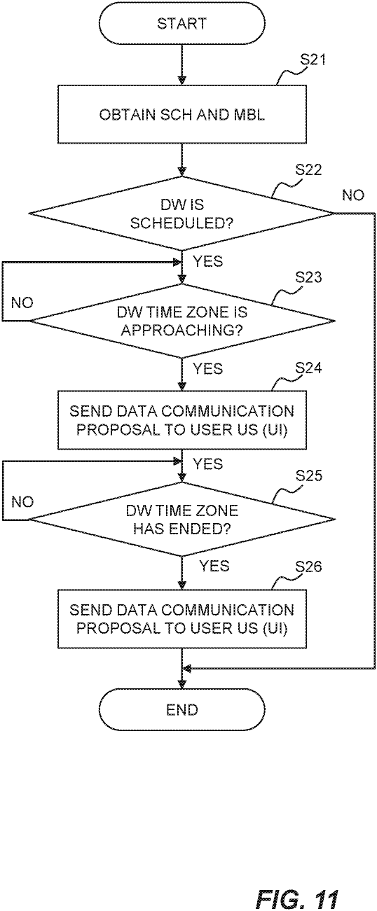

FIG. 11 a is a flowchart illustrating an example of processing performed by the information processing device 14 (the processor 14a) of the management server MS. The routine shown in FIG. 11 a is repeatedly executed at a predetermined control cycle during execution of the movement plan adopted by the user US, for example.

In the routine shown in FIG. 11, first, the schedule information SCH and the mobile vehicle information MBL are acquired (step S21). These pieces of information are acquired from the management DB12. The schedule information SCH includes the information at current time. The mobile vehicle information MBL to be acquired is the one for which the movement plan is being executed at the current time.

Following the processing of step S21, it is determined whether there is a schedule of the desk work DW (step S22). Whether there is the schedule desk work DW is scheduled is determined based on the schedule information SCH acquired in step S21. If the determination result in step S21 is negative, it is determined that there is no need to propose the data communication, and thus the current processing ends.

When the determination result in step S22 is positive, it is determined whether the time zone in which the desk work DW is scheduled is approached (step S23). For example, when the desk work DW reaches a time earlier than the scheduled time zone by a predetermined time (several tens of minutes to one hour), it is determined that the desk work DW has approached the scheduled time zone. The processing of step S23 is repeatedly executed until a positive judgment result is output.

In the processing of step S23, it may be determined whether the communication level of the communication district where the mobile vehicle MB is actually positioned exceeds the threshold Th based on the positional information and the movement plan information included in the mobile vehicle information MBL. When it is confirmed that the communication level exceeds the threshold Th, the user US can perform the data communication without stress according to the processing of the next step S24.

If the determination result of step S23 is positive, a data communication proposal is send to the user US (e.g., the user interface UI) (step S24). The proposed example of the data communication has already been described.

Following the processing of step S24, it is determined whether the time zone in which the desk work DW is scheduled has ended (step S25). For example, when the time zone in which the desk work DW is scheduled has elapsed, it is determined that the time zone in which the desk work DW is scheduled has ended. The processing of step S25 is repeatedly executed until a positive judgment result is output.

Like the processing of step S23, in the processing of step S25, it may be determined whether or not the communication level CL of the communication district CD at which the mobile vehicle MB is in the actual position exceeds the threshold Th based on the positional information and the movement plan information included in the mobile vehicle information MBL.

If the determination result of step S25 is positive, the data communication proposal is send to the user US (e.g., the user interface UI) (step S26). The example to propose the data communication has already been described.

### 2-4. Effect

According to the second embodiment described above, it is possible to propose to the user US, the candidate of the movement plan MC that realizes the desk work DW in the room of the mobile vehicle MB. In this candidate MC, information on the communication level CL in the area AR including the road from the point P1 to the point P2 is taken into consideration, and the communication district CD having the communication level CL lower than threshold Th are allowed to pass through in the time zone in which the desk work DW is scheduled. Therefore, in this case, it is expected that the degree of freedom of the generation of the candidate of the movement plan MC increases. On the other hand, if it is prohibited to pass through the communication district CD having the communication level CL exceeding the threshold Th in the time zone in which the desk work DW is scheduled, it is possible to propose a useful candidate MC to the user US who wants to concentrate on the desk work DW. Further, since the candidate MC is accepted by the user US, the desk work DW can be realized without stress during the movement by the mobile vehicle MB.

What is claimed is:

1. A method for proposing to a user a movement plan using a mobile vehicle having an equipment for web meeting and has the following features, the method comprising the steps of:
acquiring information of a schedule of the user including a movement from a first point to a second point and participation in a web meeting before and after the movement from the first point to the second point;
acquiring information of a communication level in a region including a road from the first point to the second point;
generating a candidate of the movement plan for performing a movement from the first point to the second point by the mobile vehicle based on the schedule information and the communication level information, wherein the candidate of the movement plan includes a candidate for prohibiting the mobile vehicle from being located in a communication district having a communication level lower than a threshold in a time zone scheduled to participate in the web meeting; and
sending the candidate of the movement plan to a terminal of the user.

2. The method according to claim 1, wherein:
the mobile vehicle further includes an equipment for desk work,
the schedule further includes an implementation of desk work before and after the movement from the first point to the second point, and
the candidate of the movement plan includes a candidate in which the mobile vehicle is allowed to be located in a communication district having a communication level lower than the threshold in a time zone in which the desk work is scheduled to be performed.

3. The method according to claim 1, wherein:
the mobile vehicle further includes an equipment for desk work,
the schedule further includes implementation of desk work before and after the movement from the first point to the second point,
the candidate of the movement plan includes a candidate for prohibiting the mobile vehicle from being located in a communication district having a communication level higher than the threshold in a time zone in which the desk work is scheduled to be performed.

4. The method according to claim 1,
wherein the step of generating the candidate of the movement plan comprises the steps of:
determining whether a candidate located in a communication district in which the mobile vehicle has a communication level higher than the threshold in an original time zone scheduled to participate in the web meeting is extracted;
when it is determined that the candidate is not extracted in the original time zone, changing the original time zone and determining whether a candidate located in a communication district in which the mobile vehicle has a communication level higher than the threshold is extracted in the changed time zone; and
generating a candidate in which the mobile vehicle is prohibited from being located in a communication district having a communication level lower than the threshold in the changed time zone when it is determined that the candidate is extracted in the changed time zone.

5. An apparatus for proposing a movement plan using a mobile vehicle having an equipment for a web meeting to a user, comprising:
a memory in which various information is stored; and
a processor configured to process the various information,
wherein the various information includes information on a schedule of the user including a movement from a first point to a second point and participation in a web meeting before and after the movement from the first point to the second point, and information on a communication level in a region including a road from the first point to the second point,
wherein the processor configured to:
generate a candidate of the movement plan when a movement from the first point to the second point is performed by the mobile vehicle based on the information of the schedule and the information of the communication level, the candidate of the movement plan including a candidate in which the mobile vehicle is prohibited from being located in a communication district having a communication level lower than a threshold in a time zone scheduled to participate in the web meeting; and
send the candidate of the movement plan to a terminal of the user.

6. A movement system, comprising:
a mobile vehicle including an equipment for web meeting, a driving device, and a travel control device; and
a management server including a memory in which various information is stored and a processor configured to process the various information,
wherein the various information includes information on a schedule of a user including a movement from a first point to a second point and participation in a web meeting before and after the movement from the first point to the second point, and information on a communication level in a region including a road from the first point to the second point,
wherein the processor is configured to:
generate a candidate of a movement plan when movement from the first point to the second point is performed by the mobile vehicle based on the information of the schedule and the information of the communication level, the candidate of movement plan including a candidate in which the mobile vehicle is prohibited from being located in a communication district having a communication level lower than a threshold in a time zone scheduled to participate in the web meeting;
send the candidate of the movement plan to a terminal of the user; and
when the candidate of the movement plan is accepted by the user, send movement plan information generated based on the candidate of the movement plan to the mobile vehicle,
wherein the travel control device is configured to control the driving device based on the movement plan information.
